(19) United States
(12) Patent Application Publication
(10) Pub. No.: US 2018/0357532 A1
(43) Pub. Date: Dec. 13, 2018

(54) CONVOLUTIONAL NEURAL NETWORK ON ANALOG NEURAL NETWORK CHIP

(71) Applicant: INTERNATIONAL BUSINESS MACHINES CORPORATION, Armonk, NY (US)

(72) Inventor: Hiroshi Inoue, Tokyo (JP)

(21) Appl. No.: 15/618,906

(22) Filed: Jun. 9, 2017

(51) Int. Cl. G06N 3/063; G06N 3/04

(52) U.S. Cl. CPC G06N 3/0635; G06N 3/04

(57) ABSTRACT

An apparatus, method, and system are provided. The apparatus includes an analog integrated circuit chip having a Convolutional Neural Network (CNN). The CNN includes a two-dimensional (2D) array of analog elements arranged in columns and rows and being configured to simultaneously provide a plurality of outputs by duplicating a same connection weight on a plurality of the analog elements in different ones of the columns of the 2D array. The outputs are provided from the columns.

### BACKGROUND

### Technical Field

The present invention relates generally to information processing and, in particular, to a Convolutional Neural Network (CNN) on an analog neural network chip.

### Description of the Related Art

Hardware implementations of neural networks based on various types of analog devices have been proposed. In neural network workloads, the largest part of the computation time is spent in a multiply-and-sum operation. Accordingly, there is a need for a neural network having improved speed for operations such as the multiply-and-sum operation.

### SUMMARY

According to an aspect of the present invention, an apparatus is provided. The apparatus includes an analog integrated circuit chip having a Convolutional Neural Network (CNN). The CNN includes a two-dimensional (2D) array of analog elements arranged in columns and rows and being configured to simultaneously provide a plurality of outputs by duplicating a same connection weight on a plurality of the analog elements in different ones of the columns of the 2D array. The outputs are provided from the columns.

According to another aspect of the present invention, a method is provided. The method includes forming an analog integrated circuit chip having a Convolutional Neural Network (CNN). The CNN includes a two-dimensional (2D) array of analog elements arranged in columns and rows and being configured to simultaneously provide a plurality of outputs by duplicating a same connection weight on a plurality of the analog elements in different ones of the columns of the 2D array. The outputs are provided from the columns.

According to yet another aspect of the present invention, a system is provided. The system includes an integrated circuit manufacturing system configured to convert an input specification into an analog integrated circuit chip having a Convolutional Neural Network (CNN). The CNN includes a two-dimensional (2D) array of analog elements arranged in columns and rows and being configured to simultaneously provide a plurality of outputs by duplicating a same connection weight on a plurality of the analog elements in different ones of the columns of the 2D array. The outputs are provided from the columns.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 shows an exemplary fully connected layer of a convolutional neural network, to which the present invention can be applied, in accordance with an embodiment of the present invention;

FIG. 2 shows an exemplary connection weight processing of four pixels at once by a CNN to which the present invention can be applied, in accordance with an embodiment of the present invention;

FIG. 3 shows an exemplary connection weight processing of four pixels at once by a CNN implementing connection weight duplication, in accordance with an embodiment of the present invention;

FIG. 4 shows an exemplary pooling of four pixels at once by a CNN implementing connection weight duplication, in accordance with an embodiment of the present invention;

FIG. 5 shows an exemplary method for implementing an analog CNN, in accordance with an embodiment of the present invention; and

FIG. 6 shows a block diagram of an exemplary design flow used for example, in semiconductor IC logic design, simulation, test, layout, and manufacture, in accordance with an embodiment of the present invention.

### DETAILED DESCRIPTION

The present invention is directed to a Convolutional Neural Network (CNN) on an analog neural network chip.

As noted above, in neural network workloads, the largest part of the computation time is spent in a multiply-and-sum operation. In an embodiment of the present invention, the multiply-and-sum operation can be efficiently implemented in an analog device based on Ohm's law, where connection weights are represented in electrical conductance (or resistance) and voltage and current are represented by input/output values. Activation functions, such as ReLU (Rectified Linear Unit, output=max(0, input)), can be also efficiently implemented in hardware.

Hence, in an embodiment, a CNN is provided on an analog neural network chip. The chip includes a two-dimensional (2D) array of analog elements that is used in a fully connected layer of the CNN, where a connection weight is allocated onto (shared by) multiple ones of the analog elements. This allocation allows processing multiple pixels per cycle and hence accelerates the CNN processing at the cost of an increased 2-D array size.

The number of elements to duplicate regarding connection weight allocation is controllable. Regarding such control, a larger duplication factor results in faster execution and a larger array size (2×2 duplication in the following example). In order to update the shared connection weights in a learning phase, the value in each element is updated independently and the deltas are later propagated to other elements (e.g., as done in distributed learning).

In an embodiment, when processing multiple pixels in one cycle, pooling is executed on the analog device by allocating the connection weights corresponding to neighboring pixels into one column. This is equivalent to sum pooling instead of max pooling, where max pooling requires additional information (e.g., which pixel provides the largest value), while sum pooling does not require such additional information.

Also, in an embodiment, the present invention converts a CNN description for an existing deep learning framework into one or more analog neural network chip configurations that use the aforementioned connection weight sharing approach.

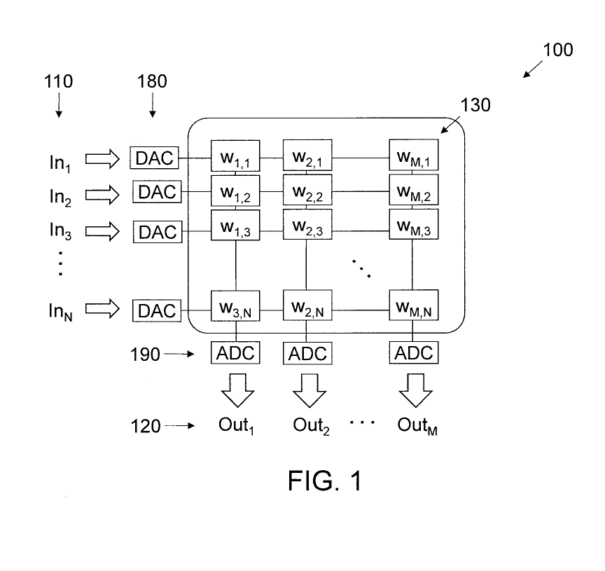

FIG. 1 shows an exemplary fully connected layer 100 of a convolutional neural network, to which the present invention can be applied, in accordance with an embodiment of the present invention. The fully connected layer 100 includes N inputs and M outputs, without bias.

In the fully connected layer 100, connection weights (W_{1,1} through W_{M,N}) are represented by a 2-D array of analog device elements 130 as electric conductance. Moreover, inputs (In₁ through In_{N}) 110 are shown on the left of FIG. 1 as voltage and outputs (Out₁ through Out_{M}) 120 are shown (read) on the bottom of FIG. 1 as electric current. In an embodiment, the following applies:

Out₁=W_{1,1}*In₁+W_{1,2}*In₂+ . . . +W_{1,N}*In_{N}.

A set of Digital to Analog Converters (DACs) 180 are connected to the inputs and a set of Analog to Digital Converters (ADCs) 190 are connected to the outputs. The clock frequency of these converters defines the clock of the layer 100.

It is to be appreciated that while FIG. 1 shows examples of analog neural network hardware to which the present invention can be applied, other types of analog neural network hardware can also be used in accordance with the teachings of the present invention, while maintaining the spirit of the present invention.

In order to implement convolutional neural networks (CNNs) on analog hardware, the following two problems are to be solved. First, in a convolution layer, many connections share one weight; hence the convolution layer requires many cycles to execute (while the size of array is typically small). Second, max pooling, a widely-used technique to reduce the size of an input (i.e., the resolution of an image), is hard to implement on analog devices.

For example, in a 3×3 convolution layer, the size of a required 2-D array is 3*3*the number of input filters (as input) and the number of output filters (as output). In the example of FIG. 1, the three different output filters are shown. Of course, other numbers of filters can also be used, while maintaining the spirit of the present invention. An input filter size of 1 is presumed. Only one pixel of the input image can be processed each cycle and hence the execution time becomes very long for large input image (about 50000 cycles for a 224×224 image). The present invention overcomes the aforementioned two problems and other related problems as readily appreciated by one of ordinary skill in the art.

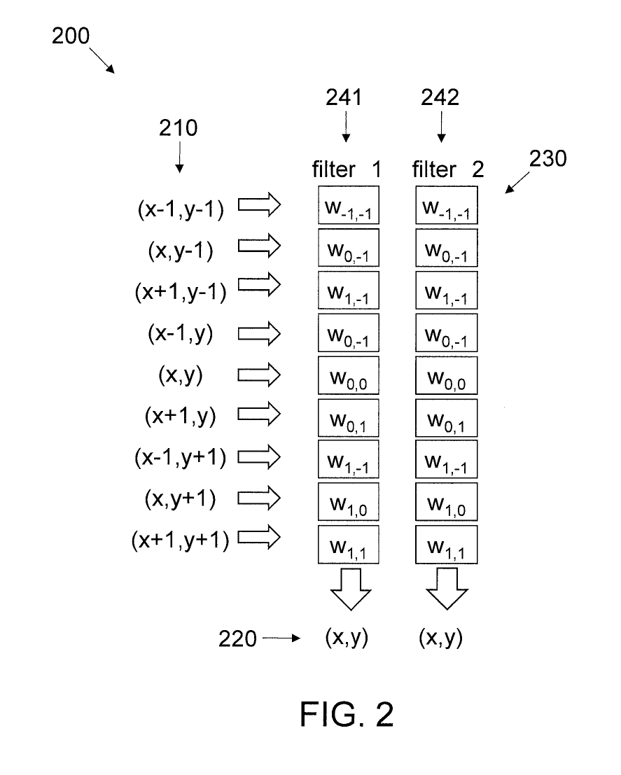

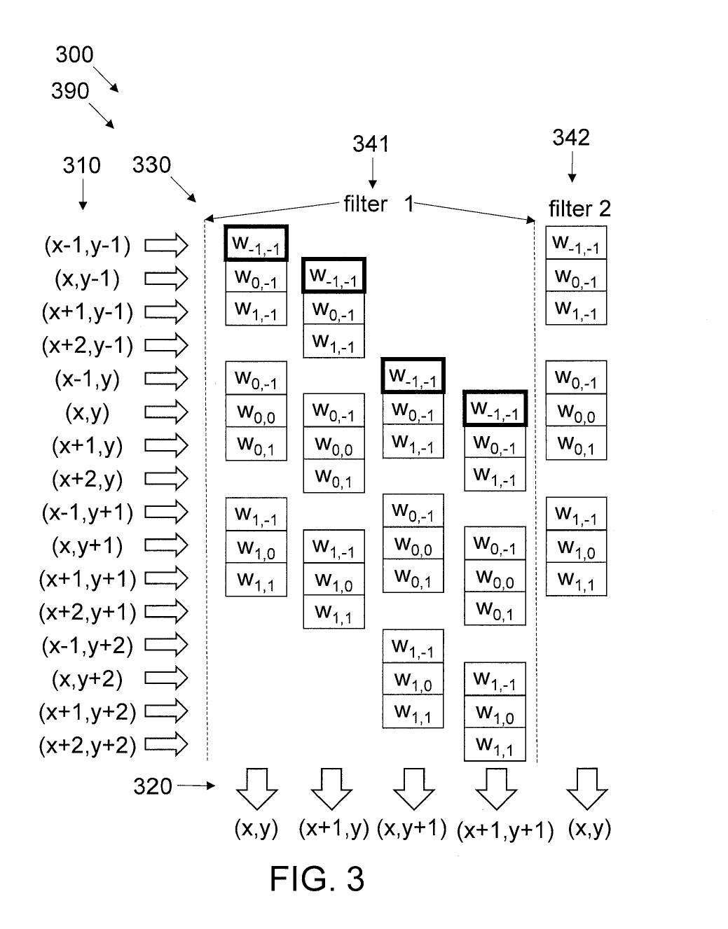

FIGS. 2 and 3 describe respective examples of connection weight processing, where the example of FIG. 2 does not share connection weights, while the example of FIG. 3 does share (duplicate) connection weights in accordance with an embodiment of the present invention. Thus, the connection weight processing approach of FIG. 2 can be improved by using the connection weight processing approach of FIG. 3. For example, in an embodiment, the processing approach and CNN involved in FIG. 2 can be converted into a CNN framework of an analog neural network as shown in FIG. 3.

FIG. 2 shows an exemplary connection weight processing 200 of four pixels at once by a CNN to which the present invention can be applied, in accordance with an embodiment of the present invention. The connection weight processing 200 involves inputs 210, outputs 220, connection weights 230, and filters 241 and 242, and does not use (connection weight) duplication in accordance with the present invention. Hence, the connection weights 230 are not duplicated. The inputs 210 can take forms including, but not limited to, the following: (x−1, y−1); (x, y−1); (x+1, y−1); (x−1, y); (x, y); (x+1, y); (x−1, Y+1); (x, y+1); and (x+1, y+1). The outputs 220 can take forms including, but not limited to, the following: (x, y).

FIG. 3 shows an exemplary connection weight processing 300 of four pixels at once by a CNN implementing connection weight duplication, in accordance with an embodiment of the present invention. The connection weight processing 300 involves inputs 310, outputs 320, connection weights 330, and filters 341 and 342. In the connection weight processing 300, each of the connection weights is duplicated 4 times using 2×2 duplication (e.g., as shown by the four blocks with connection weight W_{-1,-1} and having thicker lines than the other boxes in FIG. 3), and a connection weight is set to zero if there is no corresponding box for it (i.e., no corresponding “filled” array position) in the connection weight processing 300. The inputs 310 can take forms including, but not limited to, the following: (x−1, y−1); (x, y−1); (x+1, y−1); (x+2, y−1); x−1, y); (x, y); (x+1, y); (x+2, y); (x−1, y+1); (x, y+1); (x+1, y+1); (x+2, y+1); (x−1, y+2); (x, y+2); (x+1, y+2); and (x+2, y+2). The outputs 320 can take forms including, but not limited to, the following: (x, y); (x+1, y); (x, y+1); and (x+1, y+1).

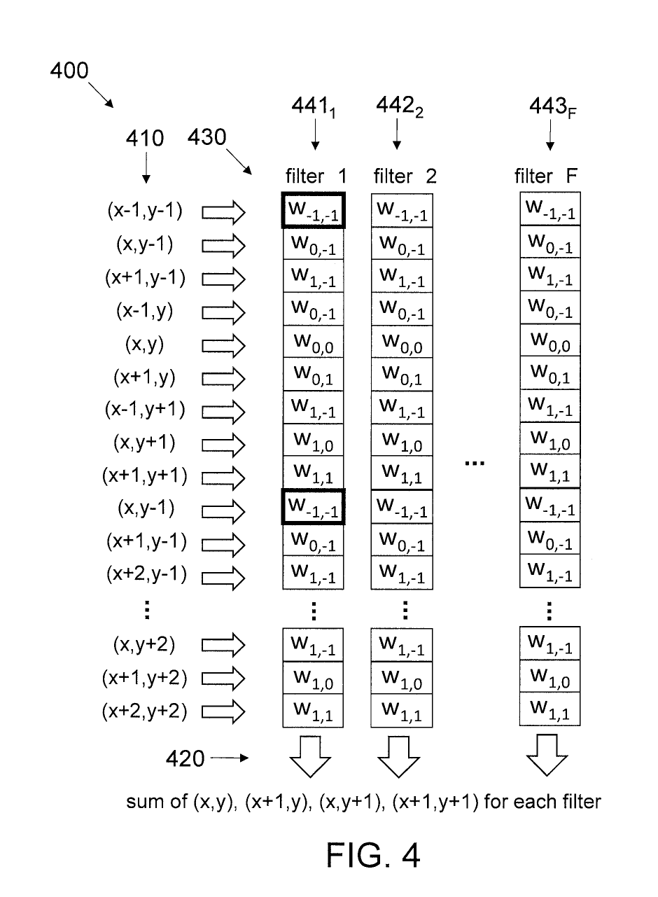

FIG. 3 also shows exemplary pooling 390, where the example of FIG. 3 does not use sum pooling. In further detail, FIG. 3 shows an exemplary pooling 300 of four pixels at once by a CNN to which the present invention can be applied, in accordance with an embodiment of the present invention. In contrast, FIG. 4 shows exemplary pooling that does use sum pooling in accordance with an embodiment of the present invention. Thus, the pooling approach of FIG. 4 can be improved by using the pooling approach of FIG. 3.

FIG. 4 shows an exemplary pooling 400 of four pixels at once by a CNN implementing connection weight duplication, in accordance with an embodiment of the present invention. The pooling 400 involves inputs 410, outputs 420, connection weights 430, and filters 440₁ through 440_{F}. The pooling 400 uses 2×2 sum pooling. The inputs 410 can take forms including, but not limited to, the following: (x−1, y−1); (x, y−1); (x+1, y−1); (x−1, y); (x, y); (x+1, y); (x−1, y+1); (x, y+1); (x+1, y+1); (x, y−1); (x+1, y−1); (x+2, y−1); . . . ; (x, y+2); (x+1, y+2); and (x+2, y+2). For each of the filters 441 and 442, the outputs 420 can take forms including, but not limited to, the following: the sum of (x, y), (x+1, y), (x, y+1), and (x+1, y+1).

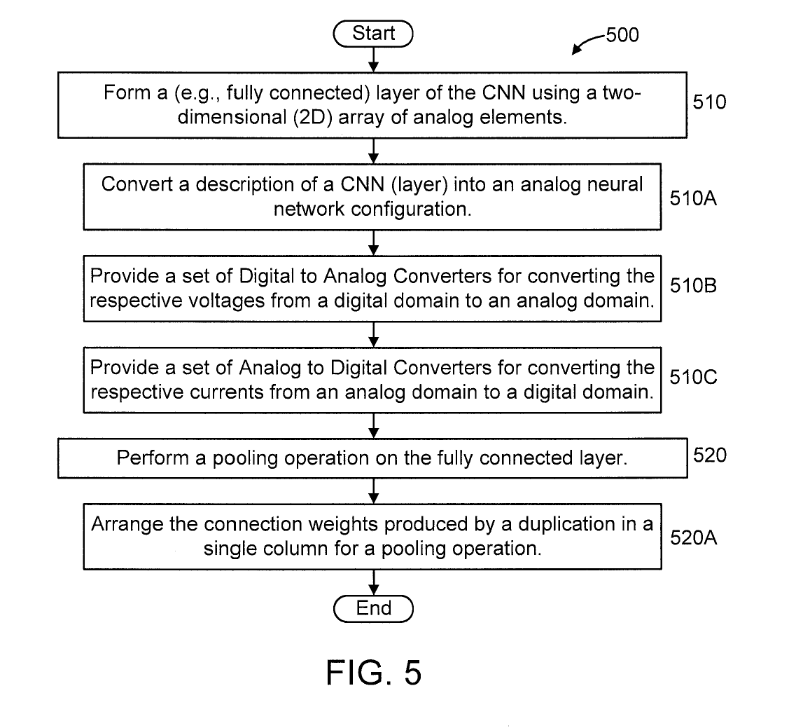

FIG. 5 shows an exemplary method 500 for implementing an analog CNN, in accordance with an embodiment of the present invention. It is to be appreciated that method 500 may omit some steps for the sake of brevity to provide focus on the inventive aspects of the present invention.

At step 510, form a layer of the CNN using a two-dimensional (2D) array of analog elements. In an embodiment, the layer is a fully connected layer. However, a non-fully connected layer can also be used in accordance with the teachings of the present invention, while maintaining the spirit of the present invention.

The 2D array of analog elements is arranged in columns and rows and is configured to simultaneously provide a plurality of CNN (layer) outputs by duplicating a same connection weight on a plurality of the analog elements in different ones of the columns of the 2D array. The outputs of the fully connected layer are provided (read) from the columns.

In an embodiment, connection weights are represented by respective electric conductances of the analog elements of the 2D array, inputs to the 2D array are implemented by respective voltages provided to the analog elements of the 2D array, and outputs from the 2D array are implemented by respective currents read from the columns in which the analog elements of the 2D array are arranged.

In an embodiment, step 510 includes steps 510A, 510B, and 510C.

At step 510A, convert a description of a CNN (layer) into an analog neural network configuration.

At step 510B, provide a set of Digital to Analog Converters for converting the respective voltages from a digital domain to an analog domain.

At step 510C, provide a set of Analog to Digital Converters for converting the respective currents from an analog domain to a digital domain.

At step 520, perform a pooling operation on the fully connected layer.

In an embodiment, step 520 includes step 520A.

At step 520A, arrange the connection weights produced by a duplication in a single column for a pooling operation. The pooling operation is equivalent to a sum pooling operation and, thus, avoid having to process the additional information implicated by the use of a max pooling operation.

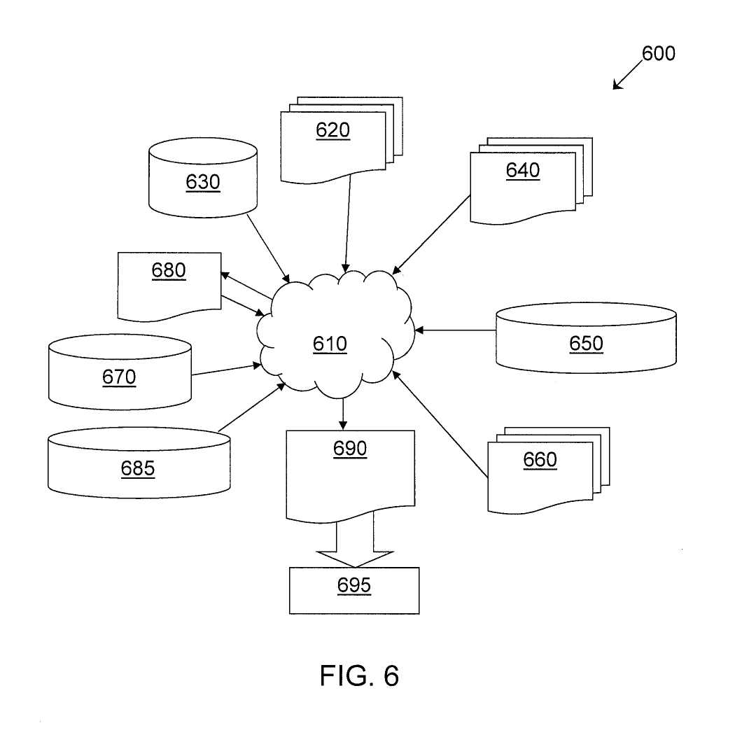

FIG. 6 shows a block diagram of an exemplary design flow 600 used for example, in semiconductor IC logic design, simulation, test, layout, and manufacture, in accordance with an embodiment of the present invention. Design flow 600 includes processes, machines and/or mechanisms for processing design structures or devices to generate logically or otherwise functionally equivalent representations of the design structures and/or devices described above and shown in FIG. 1. The design structures processed and/or generated by design flow 600 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 600 may vary depending on the type of representation being designed. For example, a design flow 600 for building an application specific IC (ASIC) may differ from a design flow 600 for designing a standard component or from a design flow 600 for instantiating the design into a programmable array, for example a programmable gate array (PGA) or a field programmable gate array (FPGA) offered by Altera Inc. or Xilinx, Inc.

FIG. 6 illustrates multiple such design structures including an input design structure 620 that is preferably processed by a design process 610. Input design structure 620 may be a logical simulation design structure generated and processed by design process 610 to produce a logically equivalent functional representation of a hardware device. Input design structure 620 may also or alternatively comprise data and/or program instructions that when processed by design process 610, generate a functional representation of the physical structure of a hardware device. Whether representing functional and/or structural design features, input design structure 620 may be generated using electronic computer-aided design (ECAD) such as implemented by a core developer/designer. When encoded on a machine-readable data transmission, gate array, or storage medium, input design structure 620 may be accessed and processed by one or more hardware and/or software modules within design process 610 to simulate or otherwise functionally represent an electronic component, circuit, electronic or logic module, apparatus, device, or system such as those shown in FIG. 1. As such, input design structure 620 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 610 preferably employs and incorporates hardware and/or software modules for synthesizing, translating, or otherwise processing a design/simulation functional equivalent of the components, circuits, devices, or logic structures shown in FIG. 1 to generate a Netlist 680 which may contain design structures such as input design structure 620. Netlist 680 may comprise, for example, compiled or otherwise processed data structures representing a list of wires, discrete components, logic gates, control circuits, 610 devices, models, etc. that describes the connections to other elements and circuits in an integrated circuit design. Netlist 680 may be synthesized using an iterative process in which netlist 680 is resynthesized one or more times depending on design specifications and parameters for the device. As with other design structure types described herein, netlist 680 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 610 may include hardware and software modules for processing a variety of input data structure types including Netlist 680. Such data structure types may reside, for example, within library elements 630 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 640, characterization data 650, verification data 660, design rules 670, and test data files 685 which may include input test patterns, output test results, and other testing information. Design process 610 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 610 without deviating from the scope and spirit of the invention. Design process 610 may also include modules for performing standard circuit design processes such as timing analysis, verification, design rule checking, place and route operations, etc.

Design process 610 employs and incorporates logic and physical design tools such as HDL compilers and simulation model build tools to process input design structure 620 together with some or all of the depicted supporting data structures along with any additional mechanical design or data (if applicable), to generate a second design structure 690. Design structure 690 resides on a storage medium or programmable gate array in a data format used for the exchange of data of mechanical devices and structures (e.g., information stored in an IGES, DXF, Parasolid XT, JT, DRG, or any other suitable format for storing or rendering such mechanical design structures). Similar to input design structure 620, design structure 690 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIG. 1. In one embodiment, design structure 690 may comprise a compiled, executable HDL simulation model that functionally simulates the devices shown in FIG. 1.

Design structure 690 may also employ a data format used for the exchange of layout data of integrated circuits and/or symbolic data format (e.g. information stored in a GDSII (GDS2), GL1, OASIS, map files, or any other suitable format for storing such design data structures). Design structure 690 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIG. 1. Design structure 690 may then proceed to a stage 695 where, for example, design structure 690: proceeds to tape-out, is released to manufacturing, is released to a mask house, is sent to another design house, is sent back to the customer, etc.

A description will now be given regarding an effect of the present invention, in accordance with an embodiment of the present invention. In this illustrative embodiment, the following convolutional neural network parameters apply.

Input: 16×16×1 (monochrome image of 16×16 pixels).
Convolution: 3×3, 14 channels.

### Pooling: 2×2.

Fully connected: 100 neurons.
Fully connected: 10 neurons (output).

Without the present invention, a forward pass takes 196 cycles for the convolution layer and also it needs to execute max pooling after AD conversion (as digital processing).

The present invention, with a duplication factor of 8×8, reduces the execution cycles of the convolution layer to only 4 cycles and additional processing for pooling is not required. The speedup becomes more significant for larger images.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1-9. (canceled)

10. A method, comprising:
forming an analog integrated circuit chip having a Convolutional Neural Network (CNN), the CNN including a two-dimensional (2D) array of analog elements arranged in columns and rows and being configured to simultaneously provide a plurality of outputs by duplicating a same connection weight on a plurality of the analog elements in different ones of the columns of the 2D array, wherein the outputs are provided from the columns.

11. The method of claim 10, further comprising configuring the CNN to perform a pooling operation by arranging connection weights produced by a duplication in a single column.

12. The method of claim 11, wherein the pooling operation is equivalent to a sum pooling operation.

13. The method of claim 10, wherein connection weights of the CNN are represented by respective electric conductances of the analog elements of the 2D array.

14. The method of claim 10, wherein respective voltages provided to the analog elements of the 2D array form respective inputs to the 2D array.

15. The method of claim 14, wherein said forming step forms the analog integrated circuit chip such that the CNN further includes a set of Digital to Analog Converters for converting the respective voltages from a digital domain to an analog domain.

16. The method of claim 10, wherein respective currents, read from the columns in which the analog elements of the 2D array are arranged, form respective outputs from the 2D array.

17. The method of claim 16, wherein said forming step forms the analog integrated circuit chip such that the CNN further includes a set of Analog to Digital Converters for converting the respective currents from an analog domain to a digital domain.

18. The method of claim 10, wherein the 2D array of analog elements is formed in a fully connected layer of the CNN.

19-20. (canceled)
